(19) United States
(12) Patent Application Publication
(10) Pub. No.: US 2005/0206171 A1
(43) Pub. Date: Sep. 22, 2005

(54) Two-sided engaging device for engaging frames of portable device

(75) Inventors: Hung-Wei Chang, Taipei (TW); Jui-Liang Ho, Taipei (TW)

Correspondence Address: HAVERSTOCK & OWENS LLP, 162 North Wolfe Road, Sunnyvale, CA, 94086, US

(73) Assignee: Arima Computer Corporation

(21) Appl. No.: 10/802,548

(22) Filed: Mar. 16, 2004

(51) Int. Cl. B23B 5/22

(52) U.S. Cl. 292/116

(57) ABSTRACT

A two-sided engaging device for engaging frames of a portable device is provided. The two-sided engaging device for engaging frames of a portable device includes a main body disposed on a first frame of the portable device; an engaging element connected to the main body and having two hooks and at least one pillar; wherein the hooks are respectively positioned at an upper side and a lower side of the engaging element; and a switch having at least one Z-shaped guiding groove for guiding the pillar passing therethrough so as to switch a position of the engaging element.

### FIELD OF THE INVENTION

The present invention is related to a two-sided engaging device, and more particularly, to a two-sided engaging device for engaging frames of a portable device.

### BACKGROUND OF THE INVENTION

Tablet PC is a kind of PC that users can use it anywhere and write on its touch screen for input with a special stylus. Because using the operating system of MS Windows XP Professional for Tablet PC, tablet PC is regarded as a new type of laptop computer.

Microsoft specifies two different designs for tablet PCs: slate form and convertible form. In the slate form, all the hard hardware is located underneath the display. A keyboard is always optional. The advantage is that slate devices are light and thin. The latter feature is particularly important for using the tablet PC as a writing pad on the desk. If the writing plate is too high for the user, stylus input will be a nuisance. Writing plates having powerful software for recognitions are substitutes for paper. In testing, the software even recognizes illegible handwriting very reliably—and without any training.

At first glance, the convertible form looks like a conventional sub-notebook. Components such as the CPU and hard drive are underneath the keyboard and the display is fixed at the usual place as shown in FIG. 1. But the screen 1a can be turned 180 degrees and then folded over onto the keyboard 1b. This turns the convertible form into a tablet PC that is more like a slate form. However, the user pays for the flexibility with heavier weight—because of its larger display 1a and integrated keyboard 1b. The convertible form would be more suitable for those who need to key in large amounts of text and occasionally use handwriting.

Unfortunately, most of convertible devices only have one side to be engaged with. When the screen is turned 180 degrees and folded over onto the keyboard, the screen is not fixed on the keyboard. That will be dangerous to a certain extent.

### SUMMARY OF THE INVENTION

It is the main object of the present invention to provide a two-sided engaging device for engaging frames of a portable device.

It is another object of the present invention to engage frames of a foldable device when the screen is turned 180 degrees.

According to one aspect of the present invention, the two-sided engaging device for engaging frames of a portable device includes a main body disposed on a first frame of the portable device; an engaging element connected to the main body and having two hooks and at least one pillar; wherein the hooks are respectively positioned at an upper side and a lower side of the engaging element; and a switch having at least one Z-shaped guiding groove for guiding the pillar passing therethrough so as to switch a position of the engaging element.

Preferably, the two-sided engaging device further includes a slider attached to the switch for a user to easily move the slider.

Preferably, the portable device is a laptop computer.

Preferably, the portable device is a tablet computer.

Preferably, the main body further comprises an elastic element urging against said first frame for generating a force in response to a press applied thereon.

Preferably, the elastic element is a spring.

Preferably, the engaging element has a structure of cross type.

Preferably, the portable device further includes a second frame.

Preferably, the second frame further includes a receiver for engaging with the engaging element.

Preferably, the first frame further includes a first opening and a second opening disposed respectively on a first surface and a second surface thereof for the engaging hooks passing therethrough.

Preferably, when the switch reaches a first position by switching the slider in a lateral direction, one of the engaging hooks protrudes the first opening of the first frame.

Preferably, when the switch reaches a second position by switching the slider in an opposite lateral direction, the other of the engaging hooks protrudes the second opening of the first frame.

According to another aspect of the present invention, the two-sided engaging device for engaging frames of a portable device includes a main body disposed on a first frame of the portable device; an engaging element connected to the main body and having two first engaging media and at least one guiding medium; wherein the first engaging media are respectively positioned at an upper side and a lower side of the engaging element; and a switch having at least one Z-shaped guiding groove for guiding the guiding medium passing therethrough so as to switch a position of the engaging element.

Preferably, the main body further includes an elastic element urging against the first frame for generating a force in response to a press applied thereon.

Preferably, the first engaging medium is a hook.

Preferably, the guiding medium is a pillar.

Preferably, when the portable device further includes a second frame.

Preferably, the second frame further includes a second engaging medium for engaging with the engaging element.

Preferably, the second engaging medium is a receiver.

Preferably, the first frame further includes a first opening and a second opening disposed respectively on a first surface and a second surface thereof for the engaging hooks passing therethrough.

Preferably, when the switch reaches a first position by switching the slider in a lateral direction, one of the first engaging media protrudes the first opening of the first frame.

Preferably, when the switch reaches a second position by switching the slider in an opposite lateral direction, the other of the first engaging media protrudes the second opening of the first frame.

The foregoing and other features and advantages of the present invention will be more clearly understood through the following descriptions with reference to the drawings, wherein:

### BRIEF DESCRIPTION OF THE DRAWINGS

FIG. 1 illustrates a conventional tablet PC according to the prior art;

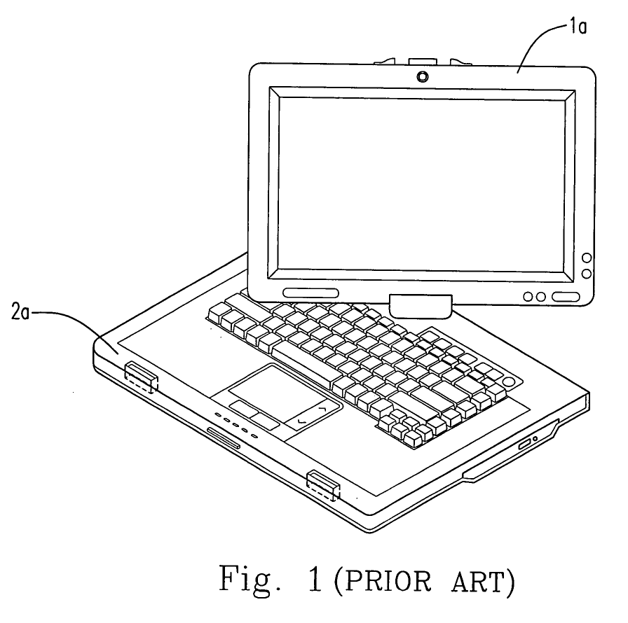

FIG. 2 illustrates components in the interior of the two-sided engaging device according to a preferred embodiment of the present invention;

FIG. 3(a)-(c) illustrates for a process of a switching operation of the switch and engaging element in the two-sided engaging device according to a preferred embodiment of the present invention; and

FIG. 4 illustrates the two-sided engaging device applied to the tablet PC according to another preferred embodiment of the present invention.

### DETAILED DESCRIPTION OF THE PREFERRED EMBODIMENT

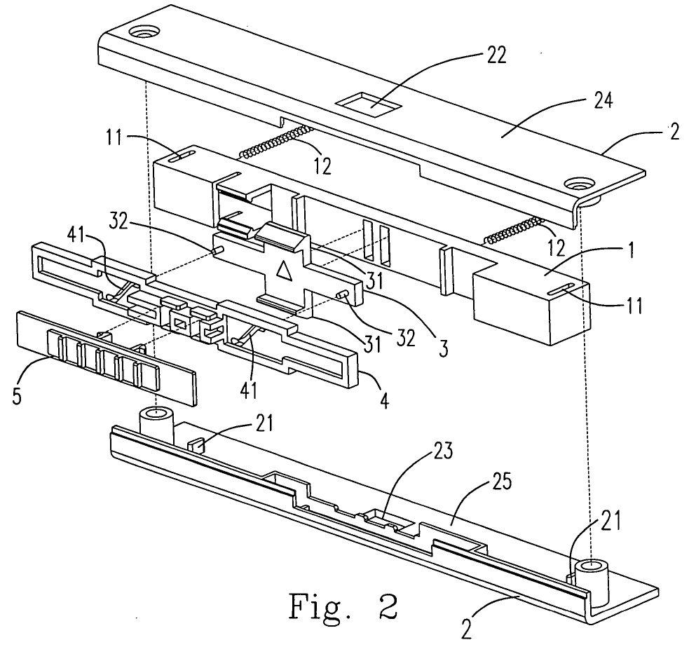

The present invention will now be described more specifically with reference to the following embodiment. Referring to FIG. 2, the two-sided engaging device for engaging frames of a tablet computer includes the main body 1, the engaging element 3, the switch 4, and the slider 5. The main body 1 is disposed on the first frame 2 of the tablet computer (not shown). The cross-shaped engaging element 3 having two hooks 31 and at least one pillar 32 is connected to the main body 1 and restrainedly moves along the vertical axis only. The hooks 31 are respectively positioned at an upper side and a lower side of the engaging element 3. The switch 4 has at least one Z-shaped guiding groove 41 for guiding the pillar 32 passing through the grooves 41 so as to switch a position of the engaging element 3. The switch 4 restrainedly moves along the horizontal axis for the left and right direction. The slider 5 is attached to the switch 4 for a user to easily push and make the slider 5 slide.

Please refer to FIG. 2, again. The main body 1 further has the grooves 11 which interact with the protruding portions 21 of the frame 1 for the main body 1 and the engaging element 3 capable of moving in the forward and backward direction. The main body 1 further includes the springs 12 for urging against between the first frame 2 and the main body 1 and generating a force in response to a press applied thereon. The first frame 2 further includes the opening 22, 23 disposed respectively on the surface 24, 25 for the hooks 31 passing therethrough.

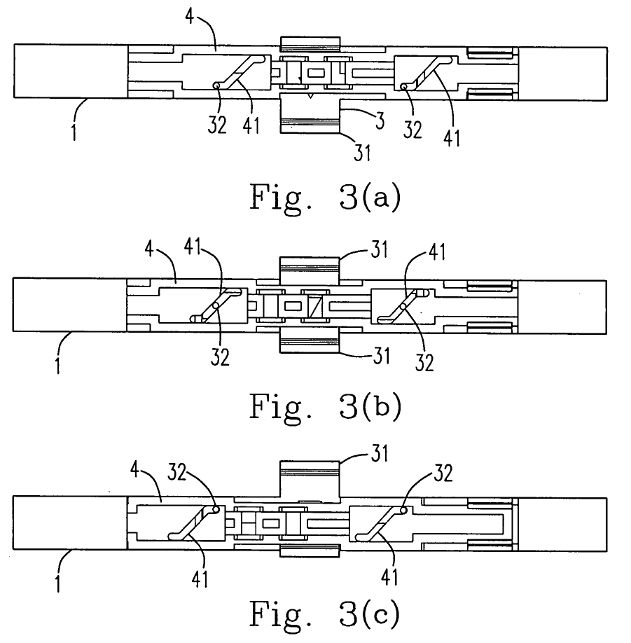

Please refer to FIG. 3. FIGS. 3(a)-(c) illustrates a process of a switching operation of the switch and engaging element in the two-sided engaging device according to a preferred embodiment of the present invention. FIG. 3(a) shows that when the switch 4 reaches a first position by switching the slider 5 to the right in a lateral direction, the lower engaging hook 31 protrudes through the opening 23 of the frame 2 (See FIG. 2). FIG. 3(b) shows that as the switch 4 is moving left to the middle, the engaging element 3 is moving up. FIG. 3(c) shows that when the switch 4 reaches a second position by switching the slider 5 to the left in an opposite lateral direction, the upper engaging hook 31 protrudes through the opening 22 of the frame 2.

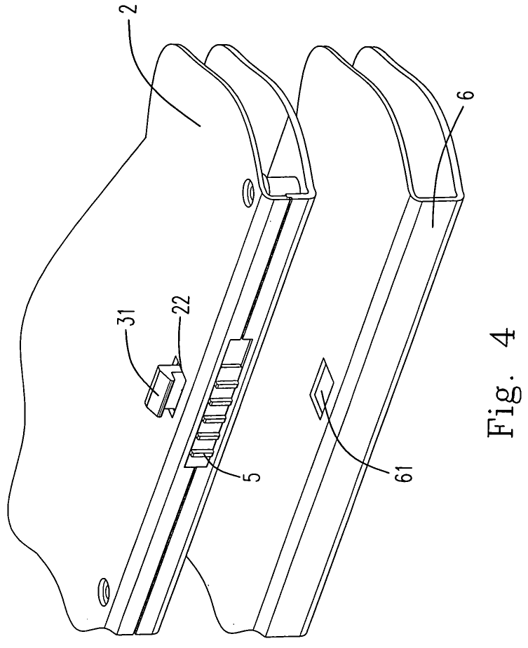

The engaging device according to the present invention is two-sided as shown in the FIG. 4. When the frame 2 (screen) is turned 180 degrees and is folded over onto the frame 6 (keyboard), the hooks 31 can be switched to another side to be engaged with the receiver 61 of the frame 6 so that the frame 2 can be fixed onto the frame 6. Hence, it will be safe and convenient and enhance the reliability when using the tablet computer. Further, while separating these two frames, it only needs to press the slider 5 so that the hooks 31 will move backward and be separated from the receiver 61 easily. Also, the advantage of the two-sided engaging device according to the present invention is that the technology of producing this two-sided engaging device is developed very well, so it will not take much time and money to produce.

As described above, the conventional engaging device for the tablet PC can't engage the screen onto the keyboard when the screen is turned 180 degrees. That will be dangerous and may cause damage when using. However, the engaging device according to the present invention not only has a good shape, but also utilizes a slider to switch the position of the engaging element. That will be convenient and increase the safety when using. Otherwise, the two-sided engaging device according to the present invention also can be applied to the portable players such as VCD/DVD players, and the likes.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation, so as to encompass all such modifications and similar structures. According, the invention is not limited by the disclosure, but instead its scope is to be determined entirely by reference to the following claims.

1. A two-sided engaging device for engaging frames of a portable device, comprising:
a main body disposed on a first frame of said portable device;
an engaging element connected to said main body and having two hooks and at least one pillar; wherein said hooks are respectively positioned at an upper side and a lower side of said engaging element; and
a switch having at least one Z-shaped guiding groove for guiding said pillar passing therethrough so as to switch a position of said engaging element.

2. The device according to claim 1, wherein said two-sided engaging device further comprises a slider attached to said switch for a user to easily move said slider.

3. The device according to claim 1, wherein said portable device is a laptop computer.

4. The device according to claim 1, wherein said portable device is a tablet computer.

5. The device according to claim 1, wherein said main body further comprises an elastic element urging against said first frame for generating a force in response to a press applied thereon.

6. The device according to claim 5, wherein said elastic element is a spring.

7. The device according to claim 1, wherein said engaging element has a structure of cross type.

8. The device according to claim 1, wherein said portable device further comprises a second frame.

9. The device according to claim 8, wherein said second frame further comprises a receiver for engaging with said engaging element.

10. The device according to claim 1, wherein said first frame further comprises a first opening and a second opening disposed respectively on a first surface and a second surface thereof for said engaging hooks passing therethrough.

11. The device according to claim 10, wherein when said switch reaches a first position by switching said slider in a lateral direction, one of said engaging hooks protrudes said first opening of said first frame.

12. The device according to claim 11, wherein when said switch reaches a second position by switching said slider in an opposite lateral direction, the other of said engaging hooks protrudes said second opening of said first frame.

13. A two-sided engaging device for engaging frames of a portable device, comprising:
a main body disposed on a first frame of said portable device;
an engaging element connected to said main body and having two first engaging media and at least one guiding medium; wherein said first engaging media are respectively positioned at an upper side and a lower side of said engaging element; and
a switch having at least one Z-shaped guiding groove for guiding said guiding medium passing therethrough so as to switch a position of said engaging element.

14. The device according to claim 13, wherein said main body further comprises an elastic element urging against said first frame for generating a force in response to a press applied thereon.

15. The device according to claim 13, wherein said first engaging medium is a hook.

16. The device according to claim 13, wherein said guiding medium is a pillar.

17. The device according to claim 13, wherein said portable device further comprises a second frame.

18. The device according to claim 17, wherein said second frame further comprises a second engaging medium for engaging with said engaging element.

19. The device according to claim 18, wherein said second engaging medium is a receiver.

20. The device according to claim 13, wherein said first frame further comprises a first opening and a second opening disposed respectively on a first surface and a second surface thereof for said engaging hooks passing therethrough.

21. The device according to claim 20, wherein when said switch reaches a first position by switching said slider in a lateral direction, one of said first engaging media protrudes said first opening of said first frame.

22. The device according to claim 21, wherein when said switch reaches a second position by switching said slider in an opposite lateral direction, the other of said first engaging media protrudes said second opening of said first frame.
